(19) United States
(12) Patent Application Publication
(10) Pub. No.: US 2025/0335730 A1
(43) Pub. Date: Oct. 30, 2025

(54) Method of Dynamically Encoding Information and Applying a Code to a Material and a Method of Decoding the Information

(71) Applicant: Deeplai Prosta Spólka Akcyjna, Lublin (PL)

(72) Inventors: Swapan Chaudhuri, Warszawa (PL); Andrzej Saja, Lublin (PL)

(73) Assignee: Deeplai Prosta Spólka Akcyjna, Lublin (PL)

(21) Appl. No.: 19/259,710

(22) Filed: Jul. 3, 2025

Related U.S. Application Data
(63) Continuation of application No. PCT/IB2023/052498, filed on Mar. 15, 2023.

(30) Foreign Application Priority Data
Jan. 6, 2023 (PL) P.443426

(51) Int. Cl. G06K 7/10; G06K 7/14; G06K 19/06

(52) U.S. Cl. CPC G06K 7/10722; G06K 7/1417; G06K 19/06037

(57) ABSTRACT

A method for encoding/decoding information using a combination with unique characteristics and patterns on the surface structure of the material includes applying a code to a material consists of a string of characters that the encoding module divides into information, and sets an individual angle of rotation of the individual separate applied stamps (1) arranged side by side, preferably in columns and rows, after which the individual separate stamps (2) are rotated by the set individual angle and the stamp (2) is applied to the material to be marked. The method of decoding the information using a digital camera consists in taking a photo of the material on which the markers (1) are applied, preferably arranged in columns and rows, and transmitting this photo-optical read to the decoding module, where the angle of the individual markers is read out and the encoded information is read out using a code.

### CROSS-REFERENCE TO RELATED APPLICATIONS

The instant application claims priority to International Patent Application No. PCT/IB2023/052498, filed Mar. 15, 2023, and to Polish Patent Application No. P.443426, filed Jan. 6, 2023, each of which is incorporated herein in its entirety by reference.

### FIELD OF THE DISCLOSURE

The present disclosure generally relates to a method for dynamically encoding an information, applying a code to a material and a method for decoding the information, in particular using a combination with unique characteristics and patterns on the surface of the material.

### BACKGROUND OF THE INVENTION

A Semacode is a system of marking objects in the real world with special codes containing URLs with a description of the marked object. The Semacode is a two-dimensional barcode based on the Data Matrix code, in which a URL with a description of object (place, building, monument, movie poster, etc.) is encoded. The address thus crafted is easily read by all kinds of mobile devices, such as mobile phones and PDAs. Thus, the user of a mobile device equipped with a camera and appropriate software is able to immediately link to a page describing the object.

The well-known is QR Code—an alphanumeric, two-dimensional, matrix, square graphic code. It is a modular and fixed-dimensional code. It allows the encoding of kanji/kana characters. In addition, it allows the encoding of characters belonging to the Arabic, Greek, Hebrew or Cyrillic alphabets as well as other user-defined symbols. The design of the code allows it to be placed and read on objects that move quickly relative to the scanner (e.g., on conveyors). The symbology is also used in various applications unrelated to the transport of parcels. Analogous to Semacode, it can be used to write and place URLs in various locations and then read with appropriately programmed mobile devices. A module in the code is a square that can take one of two colors (dark or light). A larger number of modules form so-called codewords, in which the information about the individual characters is stored. The dimension of the module is not strictly defined and depends on the capabilities of the reading and writing devices. Consequently, the dimensions of the entire code word are also variable. They additionally depend on the selected version of the code, which is dependent on the level of error correction adopted and the amount of data stored. The code uses a search pattern that allows the reader to find particular positions in the code against which the rest of the code is read. The search pattern consists of three position patterns (each being a several-module dark square surrounded by a light frame, which is surrounded by a dark frame), which are further separated from the data by a light frame of one module width (so-called separator). The position pattern markers are located in the three corners of the code. In addition, there is a so-called synchronization pattern in the code consisting of two lines with a width of one module, one of which runs horizontally and the other vertically between the position patterns. These lines contain alternately stacked dark and light dots. These make it possible to determine the version, the density of the code and the coordinates of the individual data stored in it. The second code model contains an additional axial pattern. A single axial pattern element consists of a black module surrounded by a white frame. The number of pattern elements depends on the size of the code. In addition to the data itself, the data section contains information on the format and version of the code, as well as data necessary for error correction mechanisms. A margin of at least four modules is required around the code. Another feature of the code is the so-called masking mechanism, which causes the light and dark modules to be distributed fairly evenly, resulting in an increase in the speed of image processing by scanners.

US2018/137320A1 discloses a method wherein information is dynamically encoded into a code and the code is applied to the material. The code has got a binary representation. The binary code might be displayed by printing. The set of display symbols may be images of globes shown in three-dimensional rotation and printed on a target surface. This document discloses also a system, which includes a representation engine, a symbol engine, and a translation engine. The representation engine is to provide a plurality of display symbols selected from a set of multi-dimensional cyclic symbols. The symbol engine is to receive a plurality of received symbols. The translation engine is to convert the plurality of received symbols into a plurality of display symbols.

U.S. Pat. No. 5,221,833A discloses a method wherein information is dynamically encoded into a code and the code in applied to the material. In this method a binary code is used in form of a Gray code, and this code is represented by binary expressions. An encoder uses a predefined set of rotationally distinct glyphs for encoding respective two bit long digital input values in a logically ordered sequence of such glyphs. These glyph encodings, in turn, are printed by a printer on a hardcopy recording medium in accordance with a predetermined spatial formatting rule, thereby transferring the logically ordered encoded values to the hardcopy in a self-clocking glyph code. The glyph code may be printed alone or in combination with other significant information, which might be machine and/or human readable.

EP0549315B1 discloses a method wherein information is dynamically encoded into a code and the code is applied to the material. The information to be encoded is entered into an encoder in the form of string characters, which the encoding module converts and sets the individual rotation angle of the individual isolated markers arranged side by side, in columns and rows. More precisely the encoder encodes successive n-bit long multi-bit digital input values in a logically ordered sequence of composite glyphs that are printed by the printer on a hardcopy recording medium in accordance with a spatial formatting rule to transfer the encoded digital values to the electronic document processing system. The input values are encoded as digital values that are two bits long. Moreover, the composite glyph a thickened region at its top or bottom with respect to a reference axis, depending on whether the bit that is to be encoded therein is a “1” or a “0”. The glyphic cod is printed on a sheet of paper, next is read and decrypted by scanning the sheet of paper with the code.

### BRIEF SUMMARY OF THE INVENTION

The present disclosure generally describes dynamic encoding of information that is applied to the material be verified. In one embodiment, the disclosure describes a method of dynamic encoding of information and applying the code to the material, and a method of decoding the information, especially using the structure of the material. The essence of a method of dynamically encoding information and applying the code to the material is that the information to be encoded is entered into an encoding module in the form of a string characters, graphic symbol and/or alphanumeric sign, which the encoding module converts into hexadecimal form, and sets the individual rotation angle of the individual isolated markers arranged side by side, in columns and rows, after which the markers, rotated by their individual angle, are applied to the material to be marked by embossing, stamping or hot-stamping. One of the isolated markers is dot mark for reference purposes. Placement of the positioning dot is very important to read the encoded information correctly.

In addition, after applying the code to the material, a photo is taken of the material with the code, which contains unique features characterizing the material, which includes a shape and position of elements, patterns and structure of the material.

### BRIEF DESCRIPTION OF THE SEVERAL VIEWS OF THE DRAWING(S)

FIG. 1A is a first example of a markers arrangement in accordance with the disclosure.

FIG. 1B is a second example of a markers arrangement in accordance with the disclosure.

FIG. 1C is a third example of a markers arrangement in accordance with the disclosure.

FIG. 2A is a first example of the shape of the stamp in frontal view with marked hexadecimal coding of the information by means of the corresponding angle of rotation of the stamp in accordance with the disclosure.

FIG. 2B is a second example of the shape of the stamp in the frontal view with the hexadecimal coding of the information indicated by the respective angle of rotation of the stamp in accordance with the disclosure.

FIG. 2C is a third example of the shape of the stamp in the front view with the hexadecimal coding of the information indicated by the respective angle of rotation of the stamp in accordance with the disclosure.

FIG. 2D is a fourth example of the shape of the stamp in the frontal view with the hexadecimal coding of the information indicated by the respective angle of rotation of the stamp in accordance with the disclosure.

FIG. 2E is a fifth example of the shape of the stamp in the frontal view with the hexadecimal coding of the information indicated by the respective angle of rotation of the stamp in accordance with the disclosure.

FIG. 2F is a sixth example of the shape of the stamp in frontal view with marked hexadecimal coding of the information by means of the respective angle of rotation of the stamp in accordance with the disclosure.

FIG. 3A is a first example of the encoded sequence of hexadecimal characters in a 3×3 table in accordance with the disclosure.

FIG. 3B is a second example of the encoded sequence of hexadecimal characters in a 5×5 table in accordance with the disclosure.

FIG. 3C is a third example of encoded sequence of hexadecimal characters in table 1×9 in accordance with the disclosure.

FIG. 3D is a third example of encoded sequence of hexadecimal characters in table 9×1 in accordance with the disclosure.

FIG. 3E is an example of expansion of the code layout with additional rows or columns in accordance with the disclosure.

FIG. 4A is a first example of a frame form in accordance with the disclosure.

FIG. 4B is a second example of a frame form in accordance with the disclosure.

FIG. 4C is a third example of a frame form in accordance with the disclosure.

FIG. 4D is a fourth example of a frame form in accordance with the disclosure.

FIG. 4E is a fifth example of a frame form in accordance with the disclosure.

FIG. 4F is a sixth example of a frame form in accordance with the disclosure.

FIG. 4G is a seventh example of a frame form in accordance with the disclosure.

FIG. 4H is an eighth example of a frame form in accordance with the disclosure.

FIG. 4I is a ninth example of a frame form in accordance with the disclosure.

FIG. 4J is a tenth example of a frame form in accordance with the disclosure.

FIG. 4K is an eleventh example of a frame form in accordance with the disclosure.

FIG. 5A is a first example of a code applied to a material with unique physical characteristics features in accordance with the disclosure.

FIG. 5B is a second example of a code applied to a material with unique features in accordance with the disclosure.

FIG. 5C is a third example of the code applied to a material with unique features in accordance with the disclosure.

FIG. 5D is a fourth example of the code applied to a material with unique features in accordance with the disclosure.

FIG. 5E is a unique surface physical characteristics features of the material from FIG. 5D—tree rings,

FIG. 5F is a diagram of unique surface physical characteristics features of material from FIG. 5D including cracks, delamination and the like.

FIG. 5G is a diagram of unique surface features of material from FIG. 5D, including discoloration, damage, and the like.

FIG. 5H is code applied on the surface of the material from FIG. 5D.

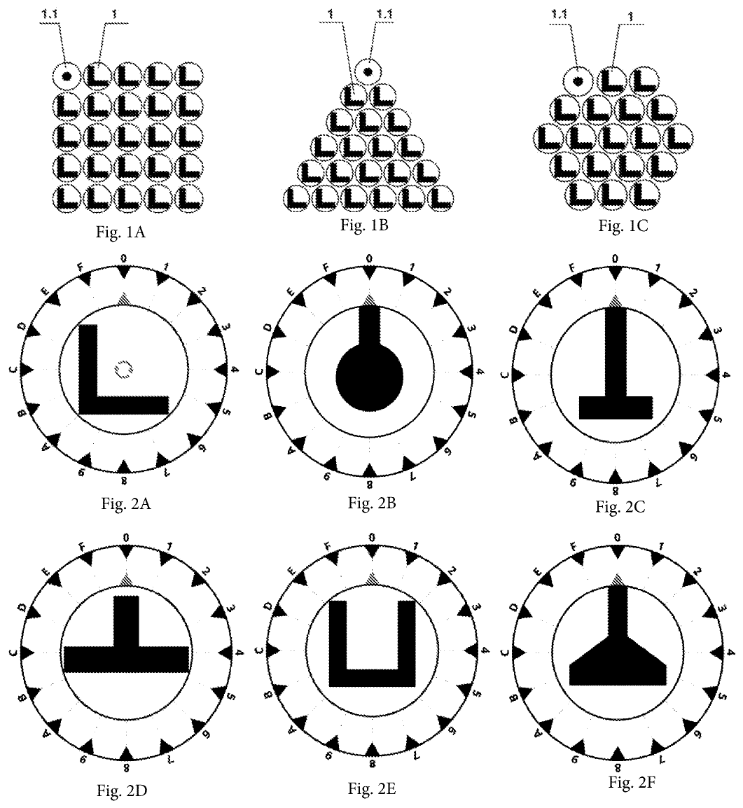

### DETAILED DESCRIPTION OF THE INVENTION

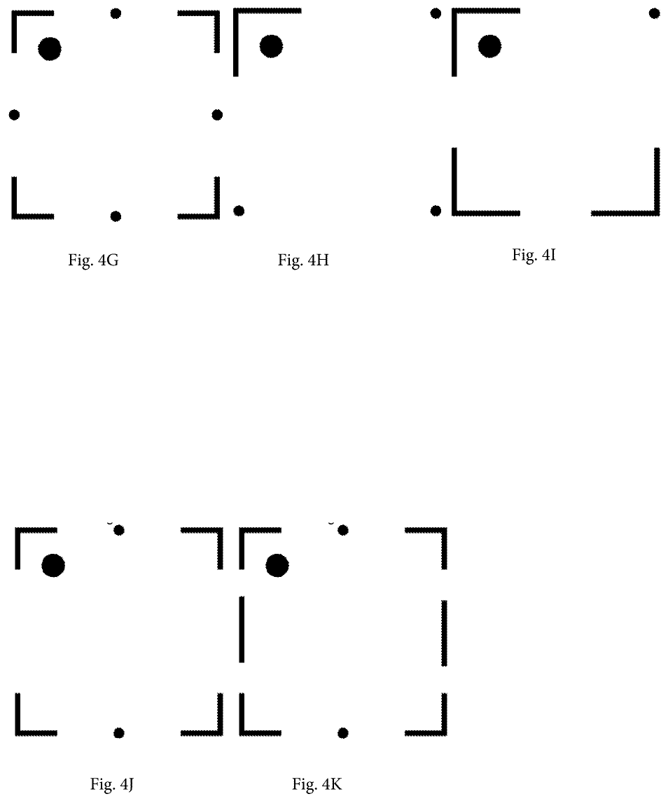

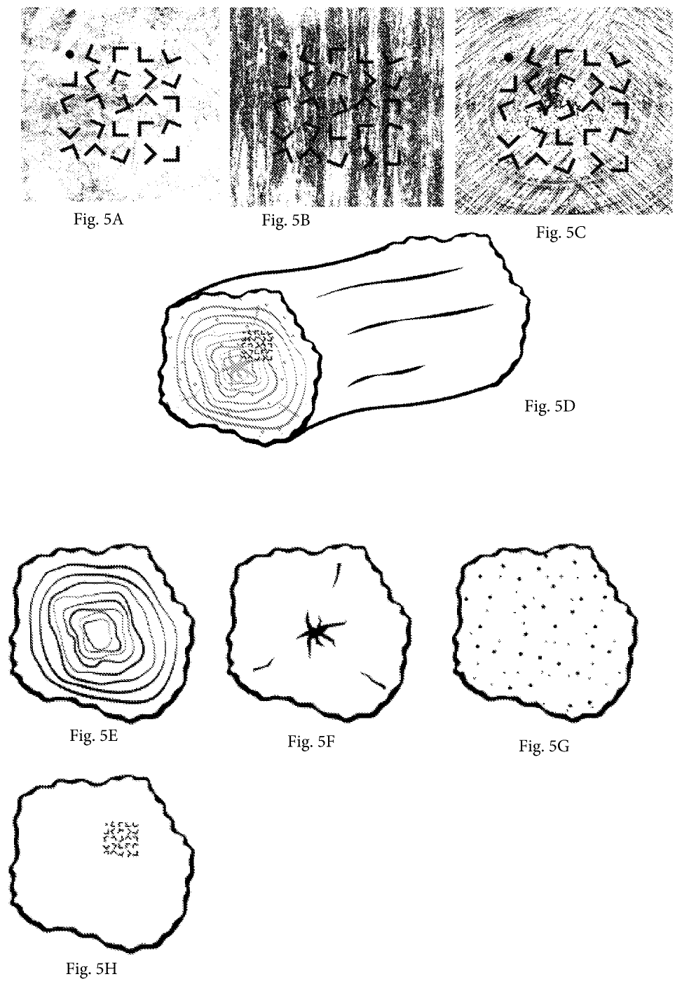

The method of dynamically encoding an information using markers applied to the material in the example is that the coding module is fed with an information to be encoded. The information to be encoded is in a form of a string of characters with a geo-localization, data and time from a satellite receiver. The encoding module converts this information into hexadecimal information and sets an individual rotation angle of 0°, 22.5° or a multiple of 22.5° for an individual L-shaped markers 1 arranged side by side in three columns and three rows—FIGS. 4A-K. The individual stamps, being markers 1, are then rotated by a pre-set individual angle and stamp 2 is applied to the material to be marked. The stamp 2 may be a blade, in the case of a material such as wood, into which the penetration of the blade will not damage the component, or the stamp may contain ink, in the case of applying the code, on a material that could be destroyed when the blade is applied.

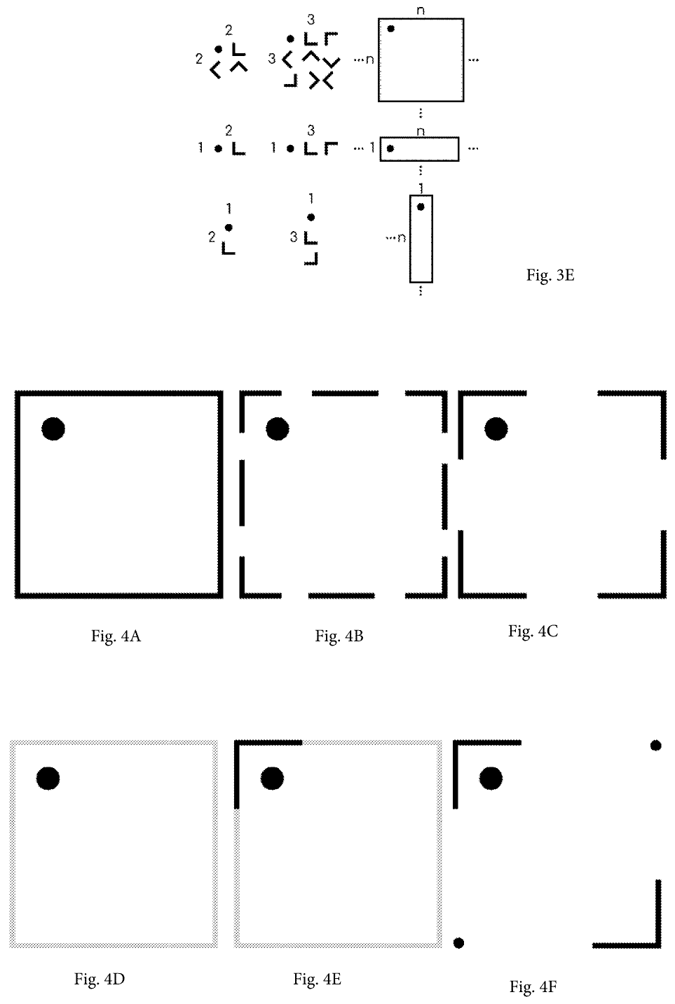

A method of dynamically encoding information using embossed/stamped/hot-stamped marks, in which the identifiers are applied to the material, is where geo-localization, time and date from a satellite receiver as information to be encoded is fed into the encoding module as a string characters, which the encoding module converts into the information and sets an individual rotation angle of 0°, 22.5° or a multiple of 22.5°, of the individual L-shaped markers 1, arranged side by side in three columns and three rows—FIG. 3A. The markers, rotated by individual angles, are then applied to the material to be marked using a marking device such as a hammer, laser, liquid nozzle or torch.

The method of decoding the information, encoded using the methods presented in the examples, using a dedicated mobile application of a mobile device or a digital camera consists of taking a photo—of the material on which the markers 1 are applied and which are arranged in columns and rows. Then, the photo is sent to the decoding module, where the angle of the individual markers is read. The encoded information is then decoded using a hexadecimal code. In addition, to confirm the authenticity of the code applied on the material, the shape and position of the elements, patterns and structures characteristic of the material are extracted from the photo on which the markers are applied using a computer software and compared, using the computer software, with the photo taken immediately after encoding. By comparing the two images, authenticity can be checked and confirmed at a rate close to 100%.

The example code used in the present patent is a type of two-dimensional grid code consisting of a series—of rows, columns of appropriately rotated markers 1 in a rectangular grid arrangement. The code consists of dark markers 1 arranged in a grid of rows and columns on a light background, or in the reverse version: light markers 1 on a dark background. In all versions, it is important to maintain a high contrast between the markers 1 and the background.

The 1.1 dot mark as a marker is a static mark placed at a specific location for reference purposes. The 1.1 dot marker is used instead of one of the fields of marker 1 to allow the code to be decoded correctly. The position of the dot 1.1 mark allows the order of the other 1 markers to be arranged so that the information can be read correctly. Special software converts the rotated 1 markers in the code to hexadecimal numbers. The amount of information encoded in the code depends on the number of rows and columns of encoded characters used, preferably hexadecimal FIG. 3A-3E.

Examples of the information capacity of a code:

3×3 matrix code (1 dot+8 hexadecimal marks)

16\hat{ }8=4 294 967 296 combinations

Matrix code 3×4 (1 dot+11 hexadecimal markers)

16\hat{ }11=17 592 186 044 416 combinations

4×4 matrix code (1 dot+15 hexadecimal markers)

16\hat{ }15=1.152921504607e+18 combinations

5×5 matrix code (1 dot+24 hexadecimal markers)

16\hat{ }24=7.922816251426e+28 combinations

### Layout Variations

Markers 1 in the code can be arranged in various vertical and horizontal combinations of rows and columns. The number of rows and columns in the code can be freely modified, depending on the amount of information needed to be encoded. The code does not give up the type of information that can be stored in it, it only specifies the layout and type of information stored in a single marker 1—hexadecimal number.

Very important in any combination is the correct placement of the positioning dot in order to read the encoded information correctly.

The positioning dot must be placed:
1. in the upper left corner in the case of rectangular codes
2. the first from the left in the case of horizontal codes
3. the first from the top in the case of vertical codes.

The information in the code is decoded in order from left to right, line by line, top to bottom.

### Marker Variants

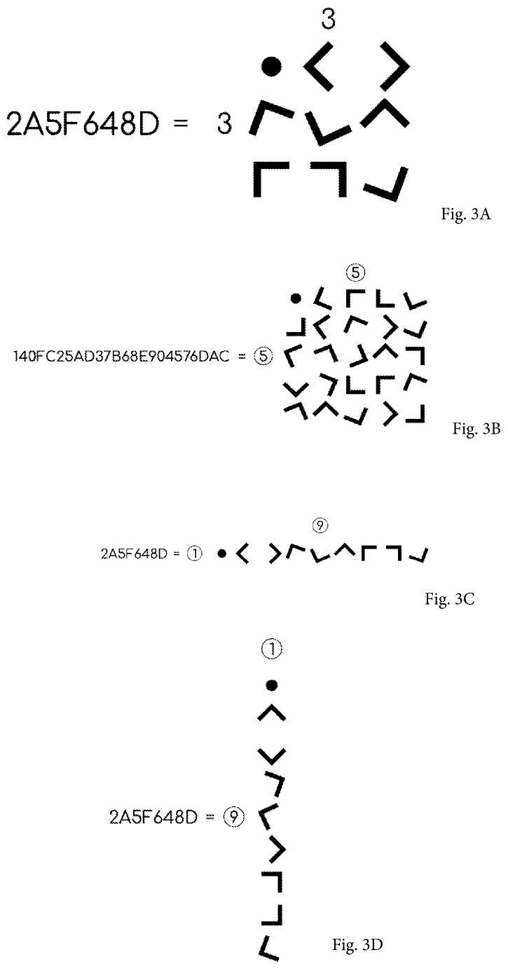

Depending on the needs, requirements and type of surface on which the code is placed, the markers 1 used to encode the hexadecimal values can take on a different appearance. Examples of the forms of markers that can be used in the code are shown in FIG. 2A-2F.

### Marker Types

One selected marker type 1 is used in the code structure specifying that all markers 1 of the code must be of the same type. Different markers 1 cannot be mixed in the code at the same time.

The placement of marker 1 in the code determines the rotation and hexadecimal coding method (direction). The corresponding element of marker 1 indicates the correct direction of encoding 5 and reading of the markers. Example symbols with marked degrees of rotation are shown in FIG. 2A-2F of the drawing and an example of the coding method in FIG. 3A-3E of the drawing.

Frame variations, many examples. Depending on the needs, requirements and type of surface on which the code is placed, the frame surrounding the code may take various forms. Where possible, the frame will not be used at all. Examples of frames are shown in FIG. 4A-4K of the drawing.

First coding example. Example of encoding of the corresponding hexadecimal values (FIG. 3A): encoded information: 2ASF648D; coded symbol used: L; versions with and without frame; rectangular, vertical and horizontal layout.

Second coding example. Example of coding of the corresponding hexadecimal values (FIG. 3B): encoded information: 140FC25AD37B68E904576DAC; coded symbol used: L; versions with and without frame; rectangular, vertical and horizontal layout.

### Dynamic Coding of Hexadecimal Information

The code allows the information in each character to be encoded as a hexadecimal number (allowed characters: 0123456789 ABCDEF) using the appropriate rotation (angle of rotation) of marker 1. Each hexadecimal symbol is expressed by the precise rotation of marker 1 around its axis.

Optionally, geo-localization, date and time data from a satellite receiver are input into the encoding module, which constitute the information which is encoded and applied to the material. In addition, after applying the code to the material, a photo is taken of the material with the code, which contains unique features characterizing the material, which includes a shape and position of elements, patterns and structure of the material.

Preferably, the individual isolated markers comprises letter L as a coding symbol.

The essence of a method of decoding the information using a digital camera is that a photo is taken of the material on which the individual isolated markers are located, arranged side by side, in columns and rows, wherein the markers have been rotated by their individual angle and applied by embossing, stamping or hot-stamping and one of the individual isolated markers is a dot mark and after taking photo, the photo is transmitted to a decoding module, in which an angle of rotation of the applied markers is read and then the encoded information is decrypted using a hexadecimal code, and wherein features characterizing the material, which includes a shape and position of elements, patterns and structure of the material, are extracted from the photo by means of a computer program.

### Advantageous Effects of Invention

The beneficial effects of the invention are:

Protection against counterfeiting—In order to obtain full protection of the product against counterfeiting, the unique coding pattern applied on the product material, consisting of the applied number of markers, is supported by a “digital fingerprint” created by the analysis and image recognition software on basis of wood structure photo. “Digital fingerprint” defines an invariable authentication match, providing definitive reference proof for the purposes of product provenance confirmation, product certification, auditing, evidential confirmation. Consequently, the detection of a counterfeit product becomes easy and demonstrates the provenance with a close to 100% evidence match, even in an attempt of counterfeiting the code mark.

Protection against theft and resale—In order to detect a stolen product, the product authentication process is accurately run defining the exact product provenance, ownership. Consequently, an information data which is a result of the product authentication process can be used as evidence in a case.

Creating product identification databases to track and monitor the CO2 footprint—Every product has a single record in the database to create a complete product database, Big Data, for further processes, audits, analyses, reports based on the source product data. In particular, it allows CO2 levels to be determined for natural products indicating their provenance based on geo-localization and a timestamp in supply chains.

Product functionality—A variable code marking applied on the product material surface is converted into a digital image, which is processed using dedicated software. The image source covers the entire product surface or a selected area from the total surface size. Advanced multidimensional image recognition processing algorithms create a ‘digital fingerprint’ of the product, taking into account the unique physical characteristics of the surface, such as selected points, patterns, marks, colors, shapes, sizes and additional references. The first digital source image is created when the unique code marking is applied. A further digital image is created when the product needs to be verified, anywhere and at any time.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of dynamically encoding information and applying a code to a material, comprising:
entering the information to be encoded into an encoding module in the form of a string characters, which the encoding module converts into hexadecimal form and sets the individual rotation angle of the individual isolated markers (1) arranged side by side, in columns and rows;
wherein the markers, rotated by their individual angle, are applied to the material to be marked by embossing, stamping or hot-stamping;
wherein one of the individual isolated markers (1) is a dot mark (1.1.); and
wherein after applying the code to the material, a photo of the material with the code is taken and the photo contains features characterizing the material, which includes a shape and position of elements, patterns and structure of the material.

2. The method according to claim 1, wherein geo-localization, date and time data from a satellite receiver are provided as inputs into the encoding module, which inputs constitute the information which is encoded and applied to the material.

3. The method according to claim 1, wherein the individual isolated markers (1) comprise a letter “L” as a coding symbol.

4. A method of decoding information using a digital camera, comprising:
taking a photo of a material on which there are applied individual isolated markers (1), arranged side by side, in columns and rows;
wherein the markers (1) have been rotated by their individual angle and applied by embossing, stamping or hot-stamping, and wherein one of the individual isolated markers (1) is a dot mark (1.1.);
after taking photo, sending the photo to a decoding module in which an angle of rotation of the applied markers is read and then the encoded information is decrypted using a hexadecimal code;
wherein features characterizing the material, which includes a shape and position of elements, patterns and structure of the material, are extracted from the photo using a computer program.
